(19) United States
(12) Patent Application Publication
(10) Pub. No.: US 2008/0066436 A1
(43) Pub. Date: Mar. 20, 2008

(54) AIR FILTER APPARATUS

(75) Inventors: Edward G. Magee, Mississauga (CA); John Magee, Campbellville (CA); Frank Sisco, Cambridge (CA)

Correspondence Address: LANG MICHENER LLP, BCE PLACE, SUITE 2500, 181 BAY STREET, TORONTO, ON, M5J 2T7, US

(73) Assignee: Delta M Incorporated, Milton (CA)

(21) Appl. No.: 11/855,470

(22) Filed: Sep. 14, 2007

Related U.S. Application Data
(60) Provisional application No. 60/825,693, filed on Sep. 14, 2006.

(30) Foreign Application Priority Data
Sep. 21, 2006 (CA) 2560483

(51) Int. Cl. B01D 46/40

(52) U.S. Cl. 55/497

(57) ABSTRACT

Amongst other things, an air filter apparatus is provided having a filter element and a frame defining a first axis and having a plurality of rails connected to one another for supporting the filter element in removably surrounded relation between the rails. The filter element is convertible between an extended configuration and a collapsed configuration, and spans the length of said first axis in the extended configuration. The filter element is adapted to releasably engage two or more of the rails, thereby to selectively retain the filter element in the extended configuration thereof, and so as to place the air filter apparatus in an operative configuration thereof.

### FIELD OF THE INVENTION

The present invention relates to the field of air filtration, and more particularly to an improved air filter apparatus.

### BACKGROUND OF THE INVENTION

A phenomena known in the art as “duct disease” and/or “sick building syndrome” affect approximately 50% of buildings (i.e., homes, office towers, and other structures) in North America. The use of air filters placed throughout ductwork in the heating, ventilation and air conditioning (“HVAC”) systems of these buildings assists in removing, for example, dirt, dust, pollen, mold, bacteria and other pathogens from air passing therethrough, thus minimizing the discharge of such contaminants from ductwork vents supplying air to the work and living areas of such buildings.

The filtration media used in such air filters is commonly a fibrous material (woven or non-woven) such as, for example, various types of cotton, polyester, glass fibers and the like. Such media typically has a relatively open matrix of fibers arranged to provide for the free flow of air therethrough, while at the same time operating to physically entrain the contaminants present in the incoming air.

Prior art air filters are commonly of the single use variety, such that they are thrown away without washing once acceptable flow rates of air therethrough are no longer attainable, as occurs when the fiber matrix of the filter media becomes clogged with contaminants.

It is also well known in the art to provide filter media in a pleated configuration in order to increase the effective surface area of the filter media (i.e., the surface area exposed to incoming airflow) beyond the cross-sectional area of the passageway or duct in which the particular filter is employed. This allows collection of a greater quantity of contaminants in the filter media before unacceptable air flow rates are encountered, thus extending the mean time before replacement of the filter becomes necessary.

Obviously, the utilization of single-use air filters results in a great deal of waste, which is ecologically undesirable. Attempts have been made to develop air filters that can be reused and/or recycled, thereby to lessen waste, whilst still providing acceptable levels of filtering quality. In order to be reusable, air filters must be capable of being vigorously washed, such that enough of the contaminants entrained in the matrix of the filter media are removed to achieve acceptably high flow rates after washing. Moreover, such vigorous washing is desirably carried out at elevated water temperatures (i.e., above about 70 degrees Celsius) and with powerful cleaning/disinfectant agents if any pathogens included in the entrained contaminants are to be neutralized. It should be noted that the filter media typically employed in prior art single-use air filters is not sufficiently robust or durable to withstand the repeated vigorous washing cycles desired in this regard.

Acceptance of recyclable air filters for HVAC applications has been hampered due to, among other things, the high volume occupied by used air filters when they are shipped to washing and/or testing facilities. As a result, it is not cost-effective to utilize prior art recyclable air filters unless there are washing facilities located on-site, or very close to, the actual site of use of the air filters. It is very uncommon to have on-site facilities for washing air filters. Any facilities that may exist are generally located remotely from the site of use, and in many cases remotely from urban and business centers.

As noted above, in order to be effective for re-use, a reusable air filter media must have substantially the same air flow capability and filtering effectiveness on its first use as on subsequent uses. While there will, of course, be some degradation in the effectiveness of reusable filter media over time (necessitating its eventual replacement), the number of cycles that a single reusable air filter media may washed and reused before requiring such replacement must be significant enough to justify the additional costs associated with manufacturing a more robust filter element and with repeated washing of same. Otherwise, in the absence of legislative intervention, significant resistance to conversion by users from single use air filters to reusable air filters will continue.

It is also desirable to have an opportunity to test the contaminants entrained by used air filters at the washing/testing facility for the presence of pathogens and the like, which may be useful in the identifying sources of contamination within a building, which contaminants may be responsible for causing said duct disease or sick building syndrome. Such testing is less likely to occur on a routine basis in the case of single-use air filters.

Additionally, prior art air filters are often susceptible to what is known in the art as “blow-by”, wherein a volume of the incoming air passes between the filter and the duct walls without passing through the filter element. This occurs in pleated filter media by way of gaps formed at the end of the folds between adjacent pleats, which gaps permit such air to pass laterally, between the filter element and the duct walls without being filtered.

Accordingly, there exists a need for an air filter apparatus having a filter element capable of being used and washed repeatedly, even at higher wash temperatures, and that has a reduced per unit shippable volume so as to facilitate economical shipping of same to and from washing and/or testing facilities, and which provides a means to minimize blow-by.

### SUMMARY OF THE INVENTION

In accordance with the present invention there is disclosed, amongst other things, an air filter apparatus comprising a washable filter element and a frame. The frame defines a first axis and has a plurality of rails connected to one another for supporting the filter element in removably surrounded relation between the rails. The filter element is convertible between an extended configuration and a collapsed configuration. The filter element spans the length of the first axis in the extended configuration. The filter element is adapted to releasably engage two or more of the rails, so as to retain the filter element in the extended configuration thereof, and so as to thereby place the air filter apparatus in its operative configuration for insertion into ductwork and the like.

In accordance with another aspect of the invention, the plurality of rails includes two or more cross rails extending substantially parallel to the first axis.

In accordance with another aspect of the invention, the plurality of rails includes two or more side rails extending substantially normal to the first axis, and the frame has one or more side portions each defined by a respective one or more of the side rails, and the cross rails extend from the side portions.

In accordance with another aspect of the invention, the frame is selectively movable along the first axis between an expanded configuration and a contracted configuration. In the expanded configuration the frame defines a greater volume between the side portions than in the contracted configuration. In its operative configuration, the frame is in the expanded configuration.

In accordance with another aspect of the invention, the frame comprises two substantially congruent segments. The segments are frictionally engagable with one another in sliding relation so as to allow selective movement of one or more of the segments along the first axis so as to move the frame between its expanded and contracted configurations.

In accordance with another aspect of the invention, the two or more cross rails include a plurality of mated pairs of the cross rails. Each of the pairs includes one of the cross rails from each of the two substantially congruent segments.

In accordance with another aspect of the invention, the apparatus further comprises one or more retention means mounted on the cross rails and each adapted to receive therein a respective one of the pairs of the cross rails in directed sliding relation. The retention means are each further adapted to allow the sliding movement of the segments along the first axis moving the frame between the expanded and contracted configurations, and to selectively retain the respective ones of the pairs so as to retain the frame in each of the expanded configuration and the contracted configuration.

In accordance with another aspect of the invention, the sliding relation is an indexed sliding relation, the indexing is provided by way of one or more complimentary undulations defined in each of the cross rails. The complimentary undulations are adapted to be engaged by the retention means when the frame is in the expanded configuration and when the frame is in the contracted configuration.

In accordance with another aspect of the invention, each of the retention means comprises a selectively lockable retention clip, mounted on the rails.

In accordance with another aspect of the invention, the filter element has a plurality of pleats formed therein, each comprised of a plurality of fold lines and two adjacent sloping side surfaces.

In accordance with another aspect of the invention, the fold lines are oriented substantially parallel to a second axis, and which second axis is transverse to the first axis.

In accordance with another aspect of the invention, in the collapsed configuration of the filter element, adjacent ones of the side surfaces of the pleats substantially contact one another.

In accordance with another aspect of the invention, the filter element has first and second ends respectively located at opposite ends of the fold lines.

In accordance with another aspect of the invention, as the segments of the frame move along the first axis so as to move the frame from the expanded configuration of the frame to the contracted configuration of the frame, the filter element moves between its extended configuration and its collapsed configuration.

In accordance with another aspect of the invention, the filter element further comprises one or more flexible gussets, wherein at least one of the first and second ends have one of the gussets attached thereto.

In accordance with another aspect of the invention, the plurality of rails includes two or more end rails extending substantially parallel to the first axis. The frame has one or more end portions each defined by a respective one or more of the end rails.

In accordance with another aspect of the invention, in the operative configuration, the flexible gussets engage the frame and are each in compressed, substantially air-sealing relation with the end portions.

In accordance with another aspect of the invention, the filter element has at least two side flaps, and a plurality of fasteners mounted on the side flaps of the filter element and each adapted to releasably engage the two or more of the rails.

In accordance with another aspect of the invention, the fasteners are adapted to releasably engage the two or more of the rails in encircling relation.

In accordance with another aspect of the invention, the two or more of the rails comprise two or more of the side rails.

In accordance with another aspect of the invention, the fasteners comprise hook and loop fasteners.

In accordance with another aspect of the invention, the frame has a plurality of corner portions with gaps defined therein.

It is thus an object of this invention to obviate or mitigate at least one of the above mentioned disadvantages of the prior art.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a right perspective view from above of a frame according to a preferred embodiment of the present invention, in an expanded configuration thereof;

FIG. 2 is a view similar to that shown in FIG. 1, with the frame shown in a contracted configuration thereof;

FIG. 3 is an enlarged view of the encircled area 3 of FIG. 2;

FIG. 4 is a perspective view from above of a filter element according to the present invention, in an extended configuration thereof;

FIG. 5 is a view similar to that shown in FIG. 4, with the filter element shown in a collapsed configuration thereof;

FIG. 6 is a right perspective view from above of an air filter apparatus according to a preferred embodiment of the present invention, shown assembled in an operative configuration thereof;

FIG. 7 is a sectional view along sight line 7-7 of FIG. 6; and,

FIG. 8 is a right perspective view from above of an alternative embodiment of a frame according to the present invention, in an expanded configuration thereof.

### DETAILED DESCRIPTION OF A PREFERRED EMBODIMENT

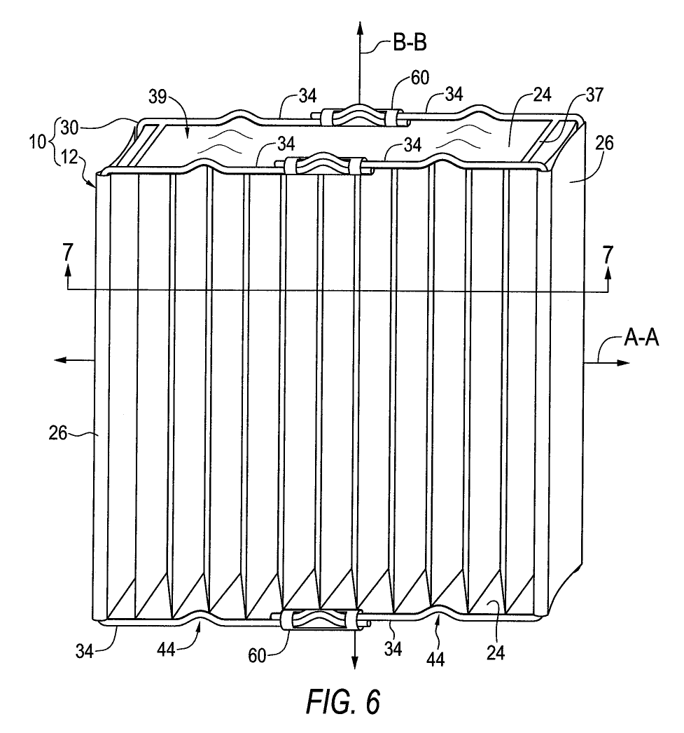

Looking to FIG. 6, there is shown therein a preferred form of air filter apparatus 10 comprising a washable filter element 12 and a frame 30 supporting the filter element 12 in removably surrounded relation. The washable filter element 12 is selectively retained within the frame 30 so as to be removable therefrom for washing and the like, in a manner that will become apparent as this description proceeds.

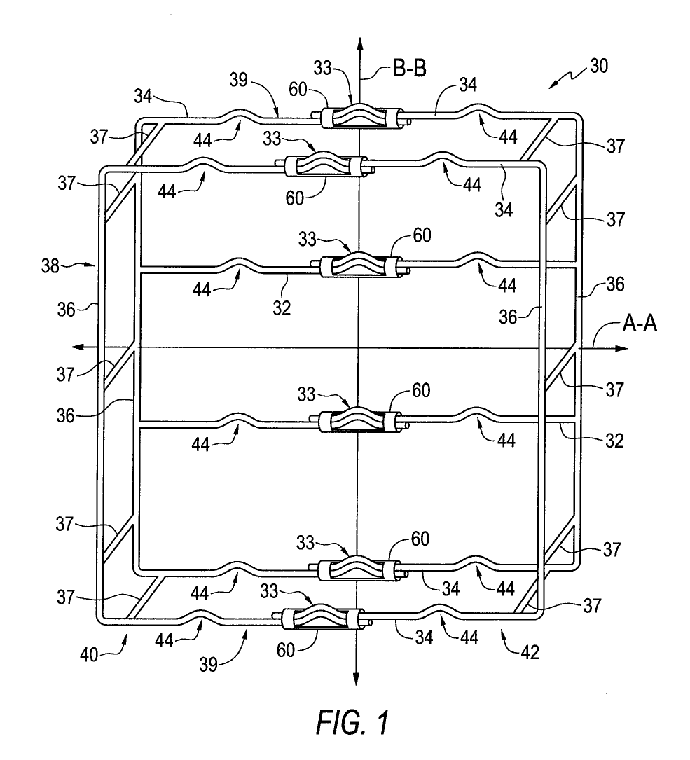

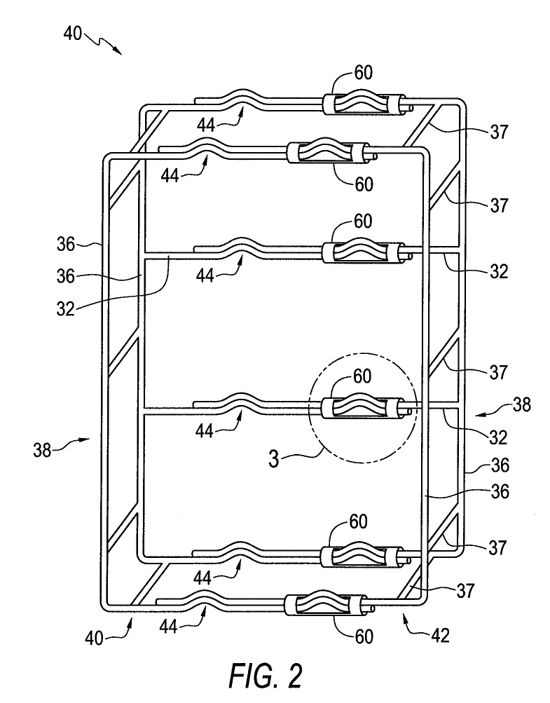

As shown in FIG. 1, the frame 30 defines a first axis A-A and a second axis B-B transverse to the first axis A-A. The frame 30 includes a plurality of rails 32, 34, 36, best seen in FIGS. 1 and 2, which rails 32,34,36 are connected to one another for so supporting the filter element 12 therebetween in removably surrounded relation between the rails. As such, they typically form a basket-like frame structure.

While shown as substantially square in FIG. 1, one skilled in the art will appreciate that the frame 30 may be constructed so as to be shaped to tightly fit within ducts (not shown) through which filtration of air is necessary, such ducts having various cross-sectional geometries including, for example, and without limitation, rectangular, circular, elliptical and triangular.

Two or more cross rails 32 are provided extending substantially parallel to the first axis A-A in the middle area of FIG. 1. Two or more side rails 36 are also provided, extending substantially normal to the first axis A-A (i.e., parallel to the second axis B-B), and defining one or more side portions 38 of the frame 30. The cross rails 32 extend from the side portions 38, as shown in FIGS. 1 and 2.

Two or more end rails 34 may also be provided, extending substantially parallel to the first axis A-A. One or more end portions 39 are each defined by a respective one or more of the end rails 34, as shown in FIGS. 1 and 2. The plurality of rails also includes connector rails 37, each connected to one or more of the rails 32, 34, 36, as shown in FIGS. 1 and 2, and oriented normal thereto, to add rigidity to the frame 30.

Each of the rails 32, 34, 36, 37 may preferably, but need not necessarily, be constructed from materials that are resistant to corrosion and/or abrasion, including various metals and plastic materials. Alternately, the rails 32, 34, 36 may be provided with a coating that is resistant to abrasion and/or corrosion, which coating may, but need not necessarily be composed of a powdered metal substance, or the like, that is chemically or magnetically adhered to the rails 32, 34, 36.

The frame 30 preferably comprises two substantially congruent segments 40, 42 as best seen in FIG. 1. The segments 40, 42 are frictionally engagable with one another in sliding relation, as described more fully below.

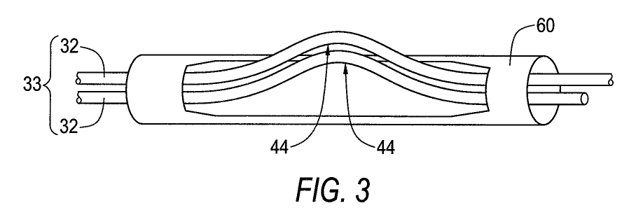

The cross rails 32 are preferably provided as a plurality of mated pairs 33 thereof, as best seen from FIGS. 1 and 3, each of which pairs 33 includes one cross rail 32 from each of the two segments 40, 42. The cross rails 32 preferably have a plurality of undulations 44 defined therein, as shown in the Figures, and described in use hereinbelow.

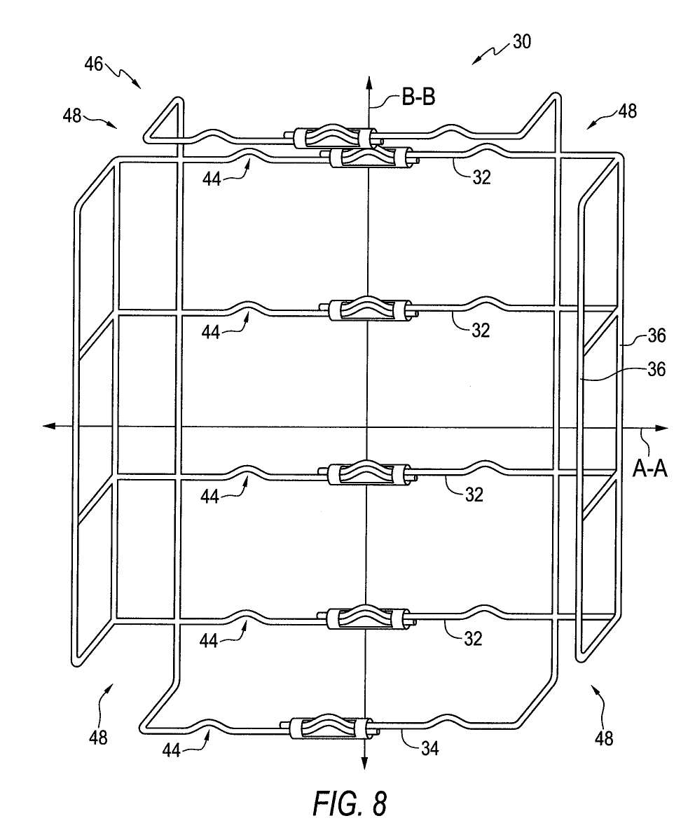

In an alternate embodiment of the frame 30, as shown in FIG. 8, the frame 30 has a plurality of corner portions 46 with gaps 48 defined therein.

These gaps 48 facilitate storage and/or shipping of multiple frames 30, as they may be mated with one another in a smaller volume than would otherwise be occupied thereby. Such gaps 48 also allow for greater manipulation of the frame 30 to fit within a particular duct or other orifice, as the side portions 38 and the end portions 39 are free from one another to allow more flexing. That is, a frame 30 with gaps 48 need not be manufactured within tolerance levels as precise as may otherwise be necessary, and still be suited for use within a particular duct without significant leakage of air around the filter element 12 supported by the frame 30, when the apparatus 10 is in its operative configuration.

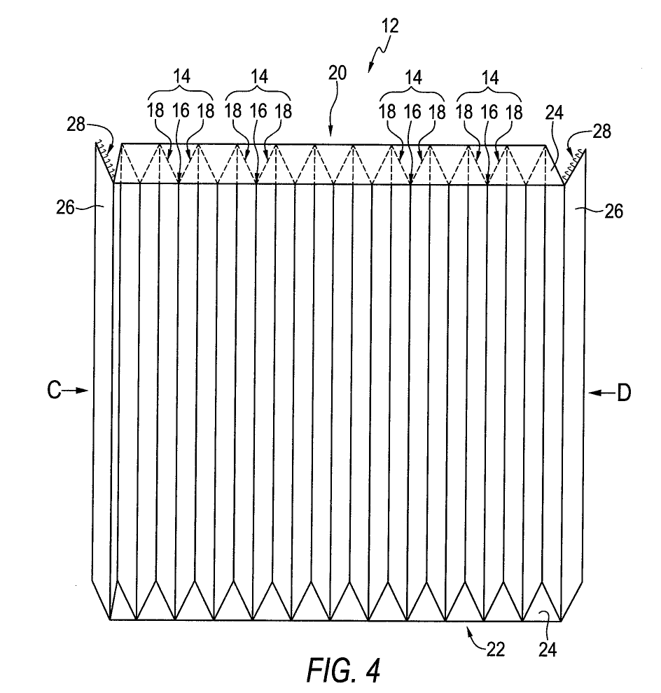

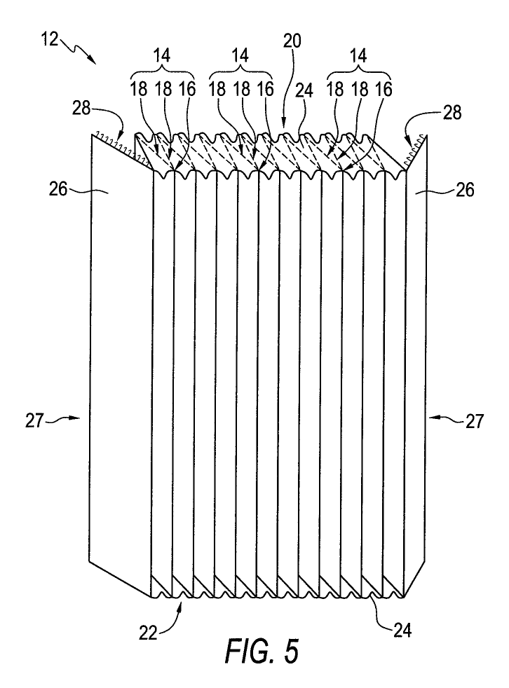

The filter element 12 has a plurality of pleats 14 formed therein, each comprised of a plurality of fold lines 16 and two adjacent sloping side surfaces 18, as shown in FIG. 6, and in phantom outline in FIGS. 4 and 5. In the preferred embodiment illustrated, the fold lines 16 are oriented substantially parallel to the second axis B-B when the apparatus is in the operative configuration shown in FIG. 6, thereby to facilitate simultaneous folding of the filter element 12 upon the collapsing of the frame 30 in the direction of axis A-A as more fully described herein. One skilled in the art will appreciate that, in instances of frames 30 and filter elements 12 of suitable geometry, multiple orientations of the filter element 12 within the frame 30 may be possible without limiting the effectiveness of the apparatus 10.

The filter element 12 has first and second ends 20, 22 respectively located at opposite ends of the fold lines 16, as shown in FIGS. 4 and 5. The filter element 12 preferably also includes one or more flexible gussets 24, attached to at least one of the first and second ends 20, 22 of the filter element 12, as shown in FIGS. 4, 5 and 6. The gussets 24 may be constructed, for example and without limitation, from cotton or woven nylon textile materials and the like, or could, alternatively, from a strip foam material (not shown).

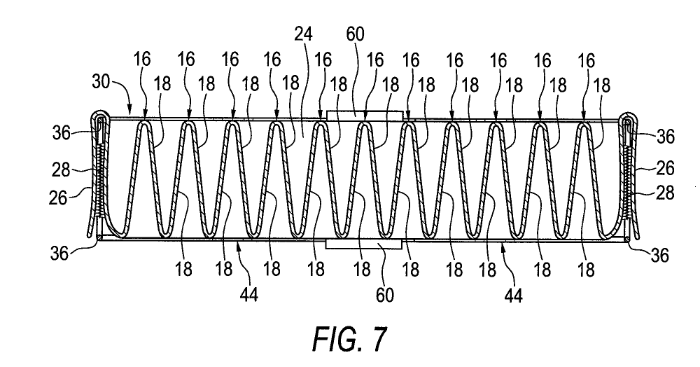

The filter element 12 has at least two side flaps 26, and a plurality of fasteners 28, preferably of a hook and loop type, as shown in cross-section in FIG. 7, mounted on interior surfaces 27 of the flaps 26. The fasteners are each adapted to releasably engage the aforementioned two of the side rails 36, preferably in encircling relation (as will be appreciated from a consideration of FIGS. 6 and 7). The fasteners 28 may also be, for example, comprised of clips (not shown) adapted to engage the frame 30. One skilled in the art will appreciate that the retention means 60 may comprise any means of selectively restraining the rails 32, 34, 36 against motion causing the segments 40, 42 of the frame 30 to move between the aforementioned expanded and contracted configurations.

The filter element 12 is convertible between an extended configuration, shown in FIG. 4, and a collapsed configuration, shown in FIGS. 5 and 6. Such conversion may be achieved by application of compressive forces in, for example, directions C and D, as denoted by correspondingly labeled arrows in FIG. 4. An elastic band (not shown) may be placed around the filter 12 to hold it in its collapsed configuration for subsequent handling and shipping to, for example, a testing/washing facility. The filter element 12 spans a significantly lesser area in the collapsed configuration than in the extended configuration, as will be appreciated from a comparison of FIGS. 4 and 5. This allows for shipping of a plurality of filters together in a single relatively small box or container. When the apparatus 10 is assembled in its operative configuration, as shown in FIG. 6, the filter element 12 spans the length of the first axis A-A. Moreover, one skilled in the art will readily appreciate that the filter element 12 spans the area bounded by or between the side portions 38 of the frame 30 when the filter element 12 is in the extended configuration thereof, and the frame 30 in its expanded configuration (i.e., when the apparatus 10 is in its operative configuration), as seen in FIG. 6.

As shown in FIG. 5, adjacent ones of the side surfaces 18 of the pleats 14 substantially contact one another when the filter element 12 is in its collapsed configuration.

The filter element 12 is adapted to releasably engage, by means of the side flaps 26, two or more of the rails (as previously described with reference to FIG. 7), preferably being two of side rails 36, so as to selectively retain the filter element 12 within the frame 30 in the extended configuration of the filter element 12. In this manner, the air filter apparatus 10 is placed in the frame 30 in the filter element's 12 operative configuration thereof, as shown in FIG. 6.

Both embodiments of the frame 30 illustrated in the Figures are selectively movable along the first axis A-A between an expanded configuration (as seen in FIG. 1, in relation to the preferred embodiment illustrated, and in relation to the alternative embodiment illustrated in FIG. 8) and a contracted configuration (as seen in FIG. 2 in relation to the preferred embodiment). As will be appreciated from a comparison of FIGS. 1 and 2, the frame 30 defines a greater volume between the side portions 38 in its expanded configuration than in its contracted configuration. In the operative configuration of the apparatus 10, the frame 30 is in its expanded configuration, as illustrated in FIGS. 1, 6 and 8.

The two frame segments 40, 42 are frictionally engagable with one another by way of the sliding frictional interaction of the mated pairs 33 of the cross rails 32 of each segment 40,42. Thus, selective movement of one or more of the segments 40, 42 along the first axis A-A is provided for, so as to move the frame 30 between its aforementioned expanded and contracted configurations.

Retention means 60 are mounted on the cross rails 32 and each adapted to receive therein a respective one of the pairs 33 of the cross rails 32 in directed sliding relation (with each of the two cross rails 32 making up each of the pairs 33 entering and exiting the retention means 60 at and from different opposed directions). The retention means 60 are each further adapted to allow the sliding movement of the segments 40, 42 along the first axis A-A moving the frame 30 between the expanded and contracted configurations thereof, and to selectively retain the respective ones of the pairs 33 so as to retain the frame 30 in each of its expanded configuration and contracted configurations (e.g., as shown in FIG. 3). Each retention means 60 preferably comprises a selectively lockable retention clip 60, mounted on the rails 32, as shown in FIGS. 1, 2, 6 and 8. Other common forms of retention means to lock the mating pairs 33 of cross rails 32 one to the other will be readily apparent to, and usable by, the average man skilled in the art to achieve such selective retention against relative sliding movement.

The sliding relation by which the segments 40, 42 interact is preferably an indexed sliding relation. Such indexing is provided by way of undulations 44 defined in each of the cross rails 32, as best shown in FIG. 3. The complimentary undulations 44 are defined at appropriate locations so as to be adapted to be engaged by the retention means 60, when the frame 30 is in each of its expanded and contracted configurations, as shown in FIGS. 1, 2 and 8.

In the operative configuration of the apparatus, the flexible gussets 24 engage the frame 30 and are each in compressed, substantially air sealing relation with the end portions 39, as shown in FIG. 6. This feature substantially lessens the opportunity for blow-by of unfiltered air past the filter element 12.

One skilled in the art will appreciate that the frame 30 and filter element 12 may be converted between their respective configurations, as described above, either separately, or in unison. Where in unison, as the segments 40, 42 of the frame 30 move along the first axis A-A, so as to move the frame 30 from its expanded configuration to its contracted configuration, the filter element 12 contemporaneously moves between its extended configuration and its collapsed configuration. Of course, such simultaneous movement is not possible in instances wherein the frame 30 and filter element 12 collapse along different axes. Where such simultaneous collapsing is possible, the filter element 12 may be shipped together with the frame 30 in a reduced volume format, without the need to first remove the filter element 12 from the frame 30. Some users of a re-usable air filter system may prefer this arrangement, as it minimizes on-site handling of dirty filters and the problems associated with same.

One skilled in the art will readily appreciate that, in some embodiments, the frame 30 may be collapsible by other means such as, for example, hinged joints (not shown), through which the rails 32, 34, 36 may be rotated about, for example, the first axis A-A, or the second axis B-B.

The undulations 44 need not be included in embodiments wherein the retention means 60 are clasps or other devices that do not require such undulations 44 for indexed engagement of the retention means 60 with the rails 32, 34, 36.

As aforementioned, the frame 30 may be constructed so as to substantially match the cross-sectional shape of, for example, a duct in an HVAC system. In all cases, the filter element 12 will preferably be constructed so as to substantially match the shape of the frame 30 so as to substantially occlude the cross-sectional area of the passageway in which the apparatus 10 is employed.

In use, the frame 30 is provided and placed in the expanded configuration thereof. Of course, such action is unnecessary when using non-collapsing frames 30, which are expressly included within the spirit and scope of this invention. The filter element 12 is attached to the side portions 38 by the side flaps 26 (as previously described), such that the filter element 12 is then in its extended configuration within the frame 30, and the apparatus 10 is in its operative configuration.

The air filter apparatus 10 is thereafter placed in the duct to be filtered (not shown). The gussets 24 compress against the walls of the duct, so as to substantially eliminate the possibility of blow-by of air past the apparatus 10. Alternatively, the duct may have a slot defined therein into which the apparatus 10 may fit and the gussets 24 may compress thereagainst in a sealed manner.

Once the filter element 12 entrains its effective capacity of trapped contaminants, or has been in place for such a period that removal thereof is deemed appropriate, the apparatus 10 is removed from the duct.

The filter element 12 may be disengaged from the frame 30 by unfastening the side flaps 26, and is thereafter placed into the collapsed configuration thereof. The filter element 12 may then be shipped in a closed container (e.g., a sealed cardboard box), to facilities whereat it may be tested and/or washed, so that it may be re-used. Alternatively, the filter element 12 may be collapsed in unison with the frame 30 without it first being removed therefrom. In such instance, the collapsed air filter assembly 10 containing both the frame 30 and the filter element 12 may be shipped together, and the filter element 12 removed at the destination for washing and/or testing.

A washed filter element 12 may be placed into the same, or a different, frame 30, as described above, and the resulting operative filter apparatus 10 may once again be shipped (in its collapsed configuration) back to the facility from whence it came for re-installation into a similar duct for continued use.

Numerous cycles (i.e., fill to capacity, then wash and use again) may be made of each washable filter element 12 prior to the need to dispose of same. The number of uses may depend on, for example, the quality of the filter medium making up the filter element 12, the volume of air flow and the volume of contaminant matter in such air flow that is caught in the filter element 12 per unit time. Suitable filtration media making up the filter element 12 may include, for example and without limitation, fibrous textile materials (woven or non-woven) such as, for example, various types of cotton, polyester, nylon, polyethylene, glass fibers and the like.

Other modifications and alterations may be used in the design and manufacture of other embodiments according to the present invention without departing from the spirit and scope of the invention, which is limited only by the accompanying claims.

For example, the frame 30 need not necessarily be collapsible, as mentioned above. In some embodiments of the present invention, a unitary and solid frame 30 may be provided to support the filter element 12 in removably surrounded relation as described above. In such instances, the filter element 12 will typically be shipped in its collapsed configuration to the washing facilities, without a corresponding frame 30.

We claim:

1. An air filter apparatus comprising:
a washable filter element; and,
a frame defining a first axis and having a plurality of rails connected to one another for supporting said filter element in removably surrounded relation between said rails;
said filter element being convertible between an extended configuration and a collapsed configuration, said filter element spanning the length of said first axis in said extended configuration; and,
wherein said filter element is adapted to releasably engage two or more of said rails, so as to selectively retain said filter element in said extended configuration thereof, thereby to place said air filter apparatus in an operative configuration thereof.

2. An apparatus according to claim 1, wherein said plurality of rails includes two or more cross rails extending substantially parallel to said first axis.

3. An apparatus according to claim 2, wherein said plurality of rails includes two or more side rails extending substantially normal to said first axis, wherein said frame has one or more side portions each defined by a respective one or more of said side rails, and wherein said cross rails extend from said side portions.

4. An apparatus according to claim 3, wherein said frame is selectively movable along said first axis between an expanded configuration and a contracted configuration, wherein in said expanded configuration said frame defines a greater volume between said side portions than in said contracted configuration, and wherein in said operative configuration said frame is in said expanded configuration.

5. An apparatus according to claim 4, wherein said frame comprises two substantially congruent segments, wherein said segments are frictionally engagable with one another in sliding relation, so as to allow selective movement of one or more of said segments along said first axis so as to move said frame between said expanded and contracted configurations.

6. An apparatus according to claim 5, wherein said two or more cross rails include a plurality of mated pairs of said cross rails, wherein each of said pairs includes one of said cross rails from each of said two substantially congruent segments.

7. An apparatus according to claim 6, further comprising one or more retention means mounted on said cross rails and each adapted to receive therein a respective one of said pairs of said cross rails in directed sliding relation; wherein said retention means are each further adapted to allow said sliding movement of said segments along said first axis moving said frame between said expanded and contracted configurations, and to selectively retain said respective ones of said pairs so as to retain said frame in each of said expanded configuration and said contracted configuration.

8. An apparatus according to claim 7, wherein said sliding relation is an indexed sliding relation, wherein the indexing is provided by way of one or more complimentary undulations defined in each of said cross rails, wherein said complimentary undulations are adapted to be engaged by said retention means when said frame is in said expanded configuration and when said frame is in said contracted configuration.

9. An apparatus according to claim 8, wherein each said retention means comprises a selectively lockable retention clip, mounted on said rails.

10. An apparatus according to claim 9, wherein said filter element has a plurality of pleats formed therein, each comprised of a plurality of fold lines and two adjacent sloping side surfaces.

11. An apparatus according to claim 10, wherein said fold lines are oriented substantially parallel to a second axis, and wherein said second axis is transverse to said first axis.

12. An apparatus according to claim 11, wherein in said collapsed configuration of said filter element, adjacent ones of said side surfaces of said pleats substantially contact one another.

13. An apparatus according to claim 12, wherein said filter element has first and second ends respectively located at opposite ends of said fold lines.

14. An apparatus according to claim 13, wherein as said segments of the frame move along said first axis so as to move said frame from said expanded configuration of said frame to said contracted configuration of said frame, said filter element moves between its extended configuration and its collapsed configuration.

15. An apparatus according to claim 14, wherein said filter element further comprises one or more flexible gussets, wherein at least one of said first and second ends have one of said gussets attached thereto.

16. An apparatus according to claim 15, wherein said plurality of rails includes two or more end rails extending substantially parallel to said first axis, and wherein said frame has one or more end portions each defined by a respective one or more of said end rails.

17. An apparatus according to claim 16, wherein in said operative configuration, said flexible gussets engage said frame and are each in compressed substantially air-sealing relation with said end portions.

18. An apparatus according to claim 17, wherein said filter element has at least two side flaps, and a plurality of fasteners mounted on said side flaps of said filter element and each adapted to releasably engage said two or more of said rails.

19. An apparatus according to claim 18, wherein said fasteners are adapted to releasably engage said two or more of said rails in encircling relation.

20. An apparatus according to claim 19, wherein said two or more of said rails comprise two or more of said side rails.

21. An apparatus according to claim 20, wherein said fasteners comprise hook and loop fasteners.

22. An apparatus according to claim 21, wherein said frame has a plurality of corner portions with gaps defined therein.

23. An apparatus according to claim 4, wherein said filter element has a plurality of pleats formed therein, each comprised of a plurality of fold lines and two adjacent sloping side surfaces.

24. An apparatus according to claim 23, wherein said fold lines are oriented substantially parallel to a second axis, and wherein said second axis is transverse to said first axis.

25. An apparatus according to claim 24, wherein in said collapsed configuration of said filter element, adjacent ones of said side surfaces of said pleats substantially contact one another.

26. An apparatus according to claim 25, wherein said filter element has first and second ends respectively located at opposite ends of said fold lines.

27. An apparatus according to claim 26, wherein said filter element further comprises one or more flexible gussets, wherein at least one of said first and second ends have one of said gussets attached thereto.

28. An apparatus according to claim 27, wherein said plurality of rails includes two or more end rails extending substantially parallel to said first axis, and, wherein said frame has one or more end portions each defined by a respective one or more of said end rails.

29. An apparatus according to claim 38, wherein in said operative configuration, said flexible gussets engage said frame and are each in compressed substantially air-sealing relation with said end portions.

30. An apparatus according to claim 29, wherein said filter element has at least two side flaps, and a plurality of fasteners mounted on said side flaps of said filter element and each adapted to releasably engage said two or more of said rails.

31. An apparatus according to claim 30, wherein said fasteners are adapted to releasably engage said two or more of said rails in encircling relation.

32. An apparatus according to claim 31, wherein said two or more of said rails comprise two or more of said side rails.

33. An apparatus according to claim 32, wherein said fasteners comprise hook and loop fasteners.

34. An apparatus according to claim 33, wherein said frame has a plurality of corner portions with gaps defined therein.
